(19) United States
(12) Patent Application Publication
(10) Pub. No.: US 2011/0025464 A1
(43) Pub. Date: Feb. 3, 2011

(54) Antenna Diversity For Wireless Tracking System And Method

(75) Inventors: Wei Geng, San Diego, CA (US); Matthew R. Perkins, San Diego, CA (US)

Correspondence Address: Clause Eight Intell. Prop. Service, P.O Box 131270, Carlsbad, CA, 92013, US

(73) Assignee: Awarepoint Corporation, San Diego, CA (US)

(21) Appl. No.: 12/554,814

(22) Filed: Sep. 4, 2009

Related U.S. Application Data
(60) Provisional application No. 61/230,087, filed on Jul. 30, 2009.

(51) Int. Cl. H04Q 5/22

(52) U.S. Cl. 340/10.1

(57) ABSTRACT

The present invention provides a solution to determine a real-time location of an object in an indoor facility utilizing the spatial and angular antenna diversity on a sensor. Specifically, the spatial diversity is achieved by placing a second antenna a predetermined distance (which is greater than one-half of the wavelength) away from the first antenna. The angular diversity is obtained by placing the second antenna at ninety degrees (perpendicular) angle of the first antenna.

### CROSS REFERENCE TO RELATED APPLICATION

The present application claims priority to U.S. Provisional Patent Application No. 61/230,087, filed on Jul. 30, 2009, which is hereby incorporated by reference in its entirety.

### STATEMENT REGARDING FEDERALLY SPONSORED RESEARCH OR DEVELOPMENT

Not Applicable

### BACKGROUND OF THE INVENTION

1. Field of the Invention

The present invention relates to wireless tracking of objects. More specifically, the present invention relates to wireless tracking of objects utilizing antenna diversity.

2. Description of the Related Art

The prior art discusses tracking objects and people using RFID technology.

Location accuracy associated with radio-frequency-based RTLS (Real-Time Location Systems), suffers from effects related to small-scale fading which often times render location estimates useless. To overcome these adverse affects, various mitigation methods have been developed that extract clues from RF-signals such as the angle of signal arrival, the time a signal was in flight, the time difference of signal arrival and the signal strength measured as a function of distance from the transmitter. To date however, no single characteristic has provided accurate location estimates for in-building environments where in-room accuracy is necessary.

Several prior art references discloses various tracking systems.

McKee et al., U.S. Pat. No. 6,915,135 discloses a system for determining presence, identity and duration of presence in a given area (a table in a restaurant) of an object (tag attached to a waiter).

Lester, U.S. Pat. No. 3,805,265 discloses a location system that uses line-of-sight radiant wave energy for signal transmission.

Christ, U.S. Pat. No. 5,977,913, discloses a radiofrequency system that is utilized within a prison and allows for an individual to be located after an alarm is triggered by the individual.

Zodnik, U.S. Patent Publication Number 2004/0147232, discloses wall-mounted (RJ-11 or RJ-45) wireless transceivers configured to only track the location of a self-identified wireless communication device in order to communicate the location of the self-identified wireless communication device to an emergency service such as 911.

One exemplary method triangulates the strongest received signals to determine the location of a tagged object. This method is based on the assumption that the receivers with the strongest received signals are the ones located closest to the tagged object. However, such an assumption is sometimes erroneous due to common environmental obstacles. Multipath effects can result in a further located receiver having a stronger received signal from a tagged object than a more proximate receiver to the tagged object, which can result in a mistaken location determination. The prior art has disclosed various means for overcoming multipath effects.

Tekinay, U.S. Pat. No. 6,259,894 for a Method For Improved Line-Of-Sight Signal Detection Using RF Model Parameters, discloses a method for reducing time-shift due to multipathing for a RF signal in an RF environment.

Close, U.S. Pat. No. 3,869,673 for a Method And Apparatus For Measuring Multipath Distortion, discloses a method for indicating multipath distortion in a received signal.

In a typical sensor network deployment each sensor simultaneously receives a signal from a transmitting device. Upon receiving the signal, each antenna measures the signal strength and reports these values to a location engine. Since the sensor that is closest to the transmitting device has a strong correlation with at least one of the antennas, it is associated with the transmitter with the corresponding room in which it transmitted its signals. Although the neighboring sensors also receive this signal, they receive the signal at a detectable difference in signal strength which is associated to the transmitted NOT being in the same room as the neighboring sensor.

The theoretical reason that the RF signal strength is used to estimate the tag location is based on the “free-space path loss” model. That is the RF signal strength decreases as the distance between the tag and sensor increases. The magnitude of decrease of the signal strength versus distance follows log-normal distribution. However, in an indoor environment, factors such as line out of sign, and multipath affect the free-space path loss model dramatically. In addition, the antenna mounted on the tags and sensors have different orientation as the tags are mobile. These factors make the received signal strength values unreliable such that the sensors with the stronger received signals are not the ones located closer to the tagged object.

In a multi-room indoor environment, the received signal strength values received by the receivers closer to the tagged object (for example, in the same room) are expected to be higher than the values received by the receivers further away from the tag (for example, in a different room with greater distance). However, this is not always the case because of factors such as transponder antenna orientation and multipath.

Different antenna diversity technologies have been used to obtain more accurate receive signal strength readings in an indoor environment, however, such antenna diversity technologies have been used to improve signal quality in wireless communication networks when the signal is low and approaching a floor-level of noise. The prior art has failed to provide an adequate solution to these problems.

### BRIEF SUMMARY OF THE INVENTION

The present invention is a method and system to improve the accuracy of a received signal strength indication (“RSSI”) based location model to help determine whether or not a mobile radiofrequency (“RF”) transponder is in a particular room.

The orientation and antenna coupling between the transmitter and sensor can contribute to large variations in signal strength that will affect the accuracy of the system. To overcome this limitation the present invention uses antenna diversity to exploit the small-scale fading characteristics. Namely, each RF sensor contains at least two antennas, spaced a non-integer-multiple of a wavelength apart, and oriented (the antenna) such that the propagation axis of each antenna is perpendicular to the other antennas.

Preferably, the present invention utilizes antenna diversity to improve received signal strength signal strength reading when the signals from a tag are above a floor-level of noise in an indoor environment.

The solution proposed is to utilize the spatial and angular antenna diversity on the receivers. Specifically, the spatial diversity is achieved by placing a second antenna at a predetermined distance (which is greater than one-half of the wavelength) away from the first antenna. The angular diversity is preferably obtained by placing the second antenna at 90 degree (perpendicular) angle of the first antenna.

One aspect of the present invention is a method for determining a real-time location of an object. The method begins with measuring a signal strength of a signal from a tag attached to an object at a first antenna on a sensor. The method also includes measuring the signal strength of the signal from the tag at a second antenna on a sensor. The method also includes determining if the signal strength measured at least one of the first antenna and the second antenna exceeds a signal strength threshold. The method also includes determining a real-time location of the object based on the signal strength measured at least one of the first antenna and the second antenna.

Preferably, the real-time location of the object is within a predetermined radius of the sensor. Preferably, the second antenna is oriented perpendicularly to the first antenna.

Another aspect of the present invention is a method for determining a real-time location of an object using a location estimation server. The method includes measuring a signal strength of a signal from a tag attached to an object at a first antenna on a sensor. The method also includes measuring the signal strength of the signal from the tag at a second antenna on a sensor. The method also includes transmitting signal strength data from the sensor to a location estimation server. The method also includes determining a real-time location of the object at the location estimation server based on the signal strength data from the sensor.

Yet another aspect of the present invention is a method for determining a real-time location of an object using a first sensor and a second sensor electromagnetically decoupled from each other. The method includes measuring a signal strength of a signal from a tag attached to an object at a first antenna on a first sensor. The method also includes measuring the signal strength of the signal from the tag at a second antenna on a second sensor. The method also includes transmitting signal strength data from the sensor to a location estimation server. The method also includes determining a real-time location of the object at the location estimation server based on the signal strength data from the sensor.

A preferred definition of eElectromagnetically decoupled is defined as not reporting the same signal strength from signals that arrive at different angles.

Yet another aspect of the present invention is a method for determining a real-time location of an object within an indoor facility. The method includes transmitting a wireless signal from a tag associated with an object. The method also includes receiving the wireless signal from the tag at a first antenna of at least one sensor of a plurality of sensors positioned within an indoor facility. The method also includes receiving the wireless signal at a second antenna of the at least one sensor of the plurality of sensors, the second antenna oriented perpendicularly to the first antenna. The method also includes processing the wireless signal received at the first antenna and the wireless signal received at the second antenna to determine a correct signal strength value for the wireless signal from the tag. The method also includes determining a real-time location of the object using the correct signal strength value for the wireless signal from the tag.

The second antenna is preferably between 1.5 inches and 3.0 inches from the first antenna. The method preferably further includes transmitting the correct signal strength to a positioning engine wherein the positioning engine determines the real-time location of the object. Alternatively, the at least one sensor preferably determines the real-time location of the object, and the method further includes transmitting the real-time location of the object to a positioning engine. The method preferably further includes measuring at least one of time, angle and received signal strength intensity of the wireless signal from the tag at least one of the first antenna and the second antenna. The method preferably further includes performing time slicing for the first antenna and the second antenna using a processor. The method alternatively further includes performing time slicing for the first antenna using a first processor and for a second antenna using a second processor. The method alternatively further includes transmitting to a positioning engine from the at least one sensor at least one of a raw signal strength reading of the wireless signal from the tag, an average signal strength reading of the wireless signal from the tag and both signal strength readings of the wireless signal from the tag. The second antenna is preferably spaced apart from the first antenna a non-integer multiple of a wavelength of the wireless signal from the tag.

Yet another aspect of the present invention is a system for determining a real-time location of an object within an indoor facility. The system preferably includes a plurality of objects, a plurality of sensors and a server. Each of the plurality of objects includes a tag which transmits a wireless signal. The sensors are positioned within the indoor facility. Each of the sensors includes a first antenna and a second antenna, with the second antenna oriented perpendicularly to the first antenna. The server is in communication with each of the sensors. The server receives real-time location data of the object from at least one of the plurality of sensors.

The tag preferably transmits a wireless signal at approximately 2.4 GigaHertz using a 802.15.4 communication protocol.

Yet another aspect of the present invention is a plug-in wireless sensor device for transmitting and receiving tracking information for an object in a facility utilizing an indoor wireless network established within the facility. The plug-in wireless sensor device includes a housing, a first antenna, a second antenna, at least one processor and a plug. The housing has a first section and a second section oriented perpendicularly to the first section. The first antenna is positioned within the first section of the housing. The second antenna is positioned within the second section of the housing. The at least one processor is positioned within the housing for processing wireless signals from at least one tag associated with an object. The wireless signals are received at each of the first antenna and the second antenna. The plug physically and electrically connects the plug-in wireless sensor device with a wall outlet of the facility. The plug extends outward from the first section of the housing.

The second antenna is preferably between 1.5 inches and 3.0 inches from the first antenna. The second antenna is preferably spaced apart from the first antenna a non-integer multiple of a wavelength of the wireless signal from the tag. The processor preferably determines a real-time location of the object for transmission over the indoor wireless network. Alternatively, the device further includes a second processor for processing a plurality of wireless signals from the at least one tag associated with an object. The processor is preferably configured to perform time slicing for the plurality of wireless signals received at each of the first antenna and the second antenna.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is schematic view of a system for determining a real-time location of an object.

FIG. 2 is a multi-floor view of a facility employing a system for determining a real-time location of an object.

FIG. 3 is a floor plan view of a single floor in a facility employing the system for determining a real-time location of an object.

FIG. 4 is a two floor view of a facility employing a system for determining a real-time location of an object.

FIG. 5 is a flow chart of a method for determining a real-time location of an object.

FIG. 6 is a flow chart of a method for determining a real-time location of an object.

FIG. 7 is a view of a dual antenna sensor.

FIG. 8 is a top plan view of a dual antenna sensor.

FIG. 9 is a view of a dual antenna sensor.

FIG. 10 is a block diagram of a system for determining a real-time location of an object.

FIG. 11 is a floor plan view of a single floor in a facility employing a prior art system for determining a real-time location of an object.

FIG. 12 is a floor plan view of a single floor in a facility employing the system for determining a real-time location of an object.

### DETAILED DESCRIPTION OF THE INVENTION

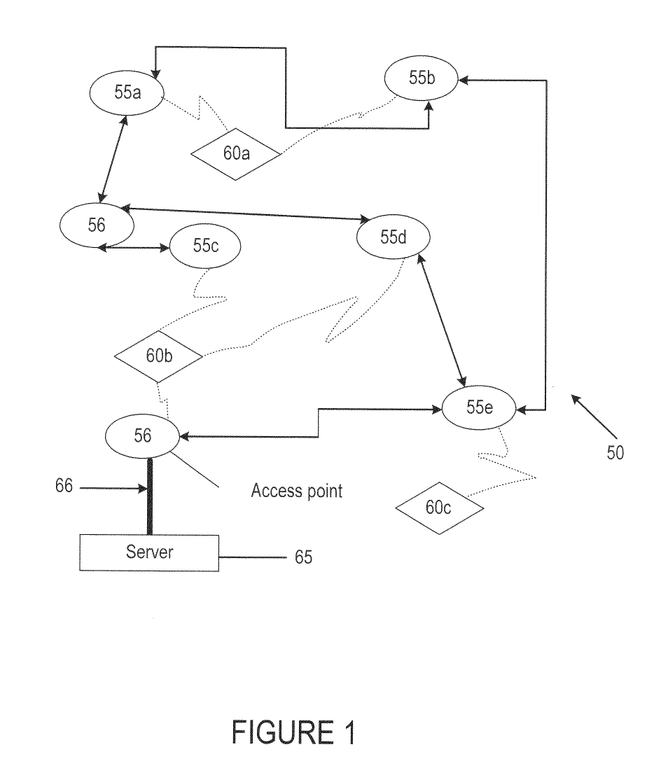

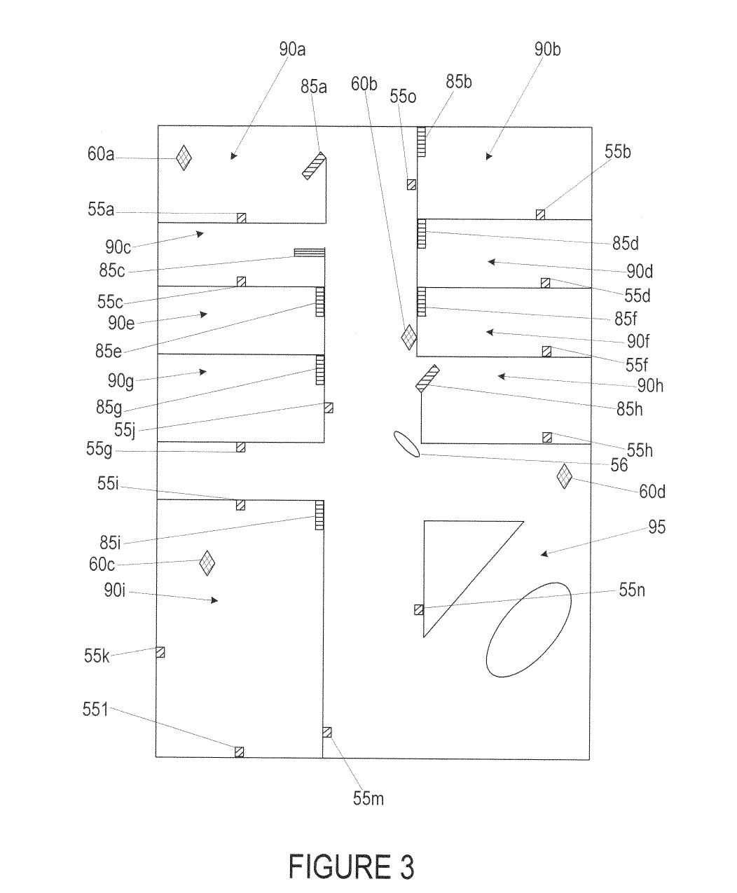

As shown in FIGS. 1-4, a system for tracking objects within a facility is generally designated 50. The system 50 is capable of determining real-time location of an object 100 within a facility 70. The system 50 preferably includes a plurality of sensors 55, a plurality of bridges 56, a plurality of tags 60 and at least one central processor 65. One example of the components of the system 50 is disclosed in U.S. Pat. No. 7,197,326, for a Wireless Position Location And Tracking System, which is hereby incorporated by reference in its entirety. A more specific example of the sensors 55 is disclosed in U.S. Pat. No. 7,324,824, for a Plug-In Network Appliance, which is hereby incorporated by reference in its entirety.

The system 50 is preferably employed at a facility 70 such as a business office, factory, home, hospital and/or government agency building. The system 50 is utilized to track and locate various objects positioned throughout the facility 70. The tags 60 preferably continuously transmit signals on a predetermined time cycle, and these signals are received by sensors 55 positioned throughout the facility 70. Alternatively, the tags 60 transmit signals in a random, ad-hoc or dynamic manner, and these signals are received by the sensors 55 positioned throughout the facility 70. The sensors 55 transmit the data from the tags 60 to a bridge 56 for transmission to a server 65. If a sensor 55 is unable to transmit to a bridge 56, the sensor 55 may transmit to another sensor 55 in a mesh network-like system for eventual transmission to a bridge 56. In a preferred embodiment, a transmission is sent from a transmission distance of six sensors 55 from a bridge 56. Alternatively, a transmission is sent from a transmission distance ranging from ten to twenty sensors 55 from a bridge 56. The central processor 65 preferably continuously receives transmissions from the sensors 55 via the bridges 56 concerning the movement of objects 100 bearing a tags 60 within the facility 70. The central processor 65 processes the transmissions from the sensors 55 and calculates a real-time position for each of the objects 100 bearing a tag 60 within the facility 70. The real-time location information for each of the objects 100 bearing a tag 60 is preferably displayed on an image of a floor plan of the facility 70, or if the facility 70 has multiple floors, then on the floor plan images of the floors of the facility 70. The floor plan image may be used with a graphical user interface of a computer, personal digital assistant, or the like so that an individual of the facility 70 is able to quickly locate objects 100 within the facility 70.

As shown in FIG. 1, the system 50 utilizes sensors 55 to monitor and identify the real-time position of non-stationary objects bearing or integrated with tags 60. The sensors 55a-f preferably wirelessly communicate with each other (shown as double arrow lines) and with a central processor 65 through a wired connection 66 via at least one bridge 56, such as disclosed in the above-mentioned U.S. Pat. No. 7,324,824 for a Plug-In Network Appliance. The tags 60a-c transmit signals at various power levels (shown as dashed lines) which are received by the sensors 55a-e, which then transmit signals to bridges 56 for eventual transmission to a central processor 65. The central processor 65 is preferably located on-site at the facility 70. However, the system 50 may also include an off-site central processor 65, not shown.

In a preferred embodiment, each tag 60 preferably transmits a radio frequency signal of approximately 2.48 GigaHertz (“GHz”). The communication format is preferably IEEE Standard 802.15.4.

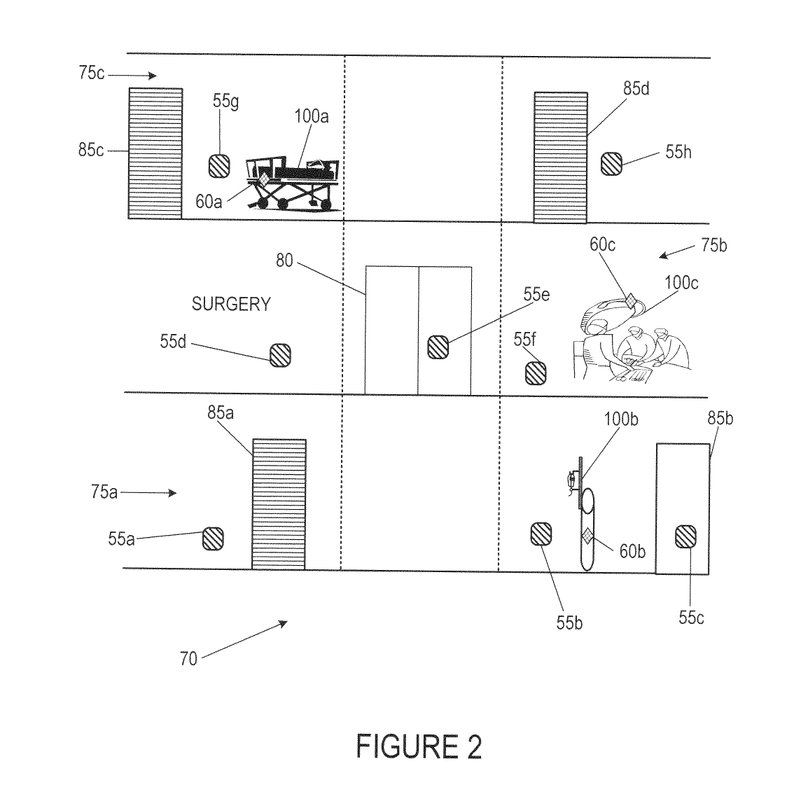

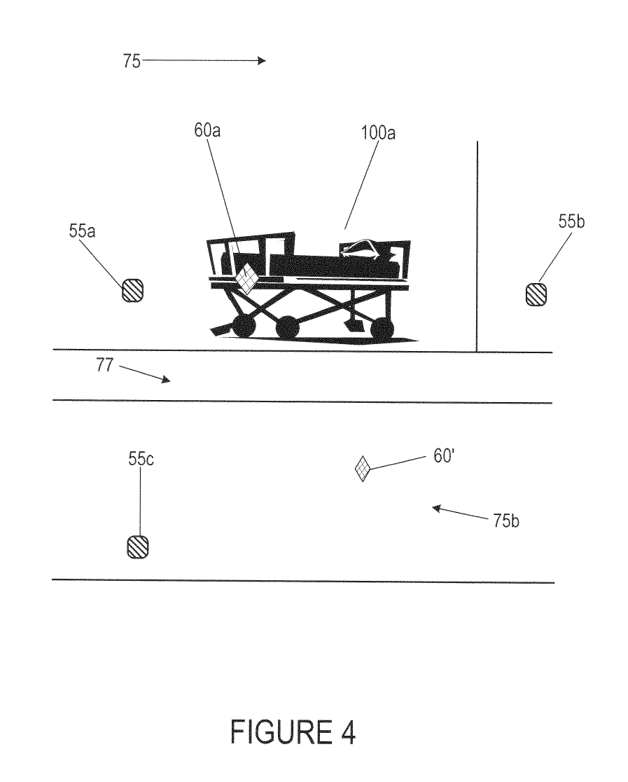

As shown in FIGS. 2-4, the facility 70 is depicted as a hospital. The facility 70 has a multitude of floors 75a-c. An elevator 80 provides access between the various floors 75a, 75b and 75c. Each floor 75a, 75b and 75c has a multitude of rooms 90a-i, with each room 90 accessible through a door 85. Positioned throughout the facility 70 are sensors 55a-o for obtaining readings from tags 60a-d attached to or integrated into non-stationary objects 100a, 100b (see FIGS. 2 and 4). A bridge 56 is also shown for receiving transmissions from the sensors 55 for processing by the central processor 65.

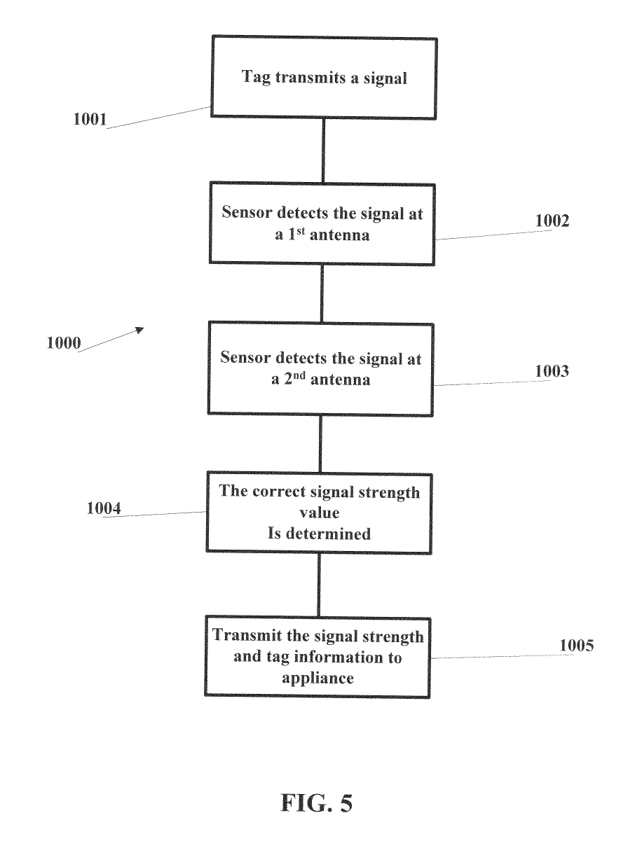

A method 1000 for determining a real-time location of an object within an indoor facility is illustrated in FIG. 5. At block 1001, a tag attached to a mobile object transmits a wireless signal. At block 1002, the wireless signal from the tag is received at a first antenna of a sensor positioned within a room of a facility. At block 1003, the wireless signal from the tag is received at a second antenna of the sensor positioned within a room of a facility. The sensor preferably has a single processor. At block 1004, the correct signal strength value of the wireless signal is determined at the sensor by processing the wireless signal received at the first antenna and processing the wireless signal received at the second antenna. At block 1005, the signal strength and tag information is transmitted to an appliance. Preferably the appliance is a positioning engine utilized for determining the real-time location of the mobile object within the indoor facility.

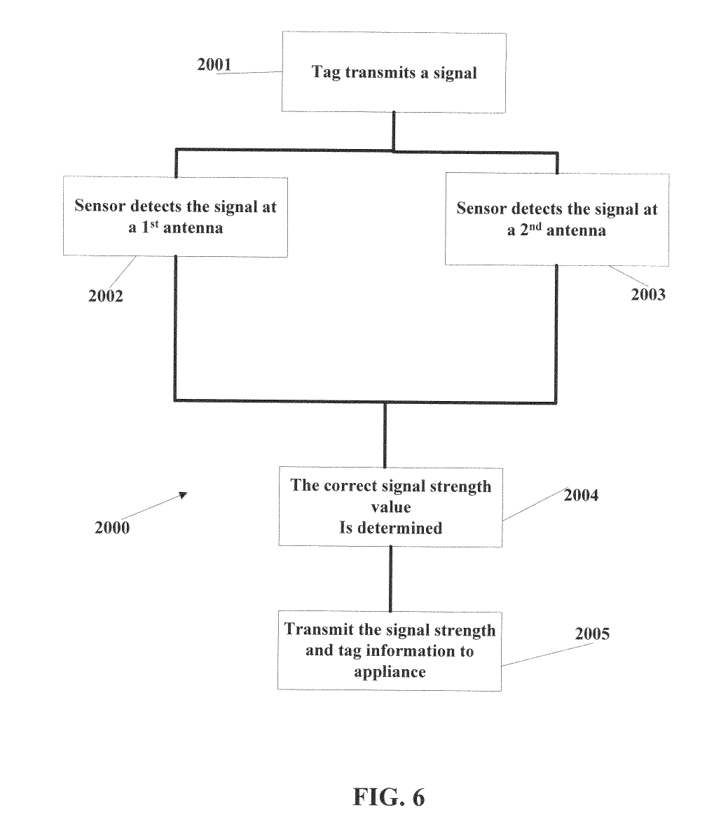

A method 2000 for determining a real-time location of an object within an indoor facility is illustrated in FIG. 6. At block 2001, a tag attached to a mobile object transmits a wireless signal. At block 2002, the wireless signal from the tag is received at a first antenna of a sensor positioned within a room of a facility. At block 2003, the wireless signal from the tag is received at a second antenna of the sensor positioned within a room of a facility. The sensor preferably has two processors, one for each antenna. At block 2004, the correct signal strength value of the wireless signal is determined at the sensor by processing the wireless signal received at the first antenna and processing the wireless signal received at the second antenna using a second processor. At block 2005, the signal strength and tag information is transmitted to an appliance. Preferably the appliance is a positioning engine utilized for determining the real-time location of the mobile object within the facility.

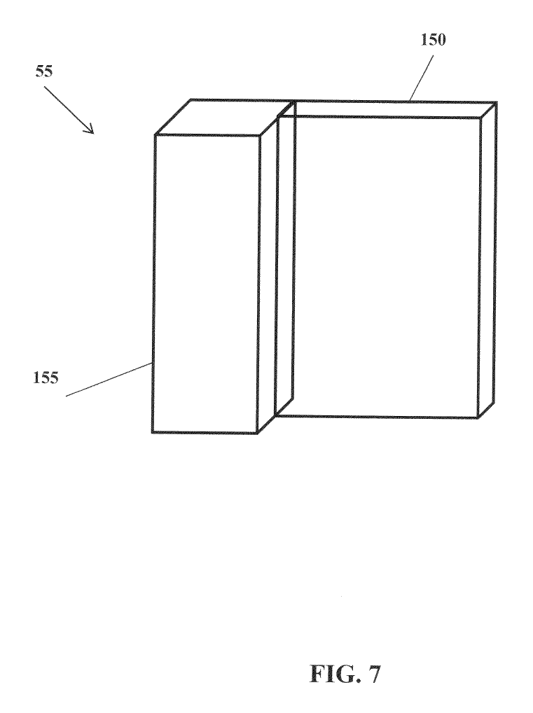

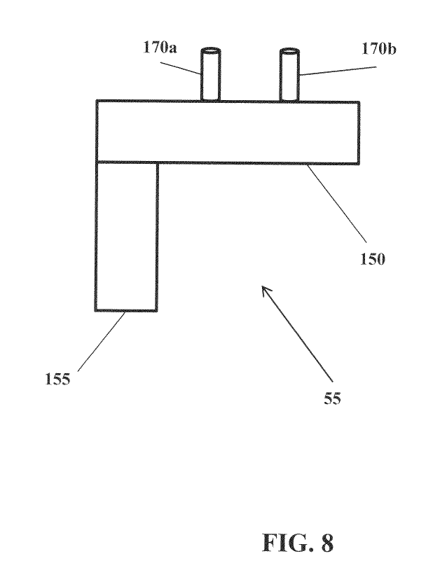

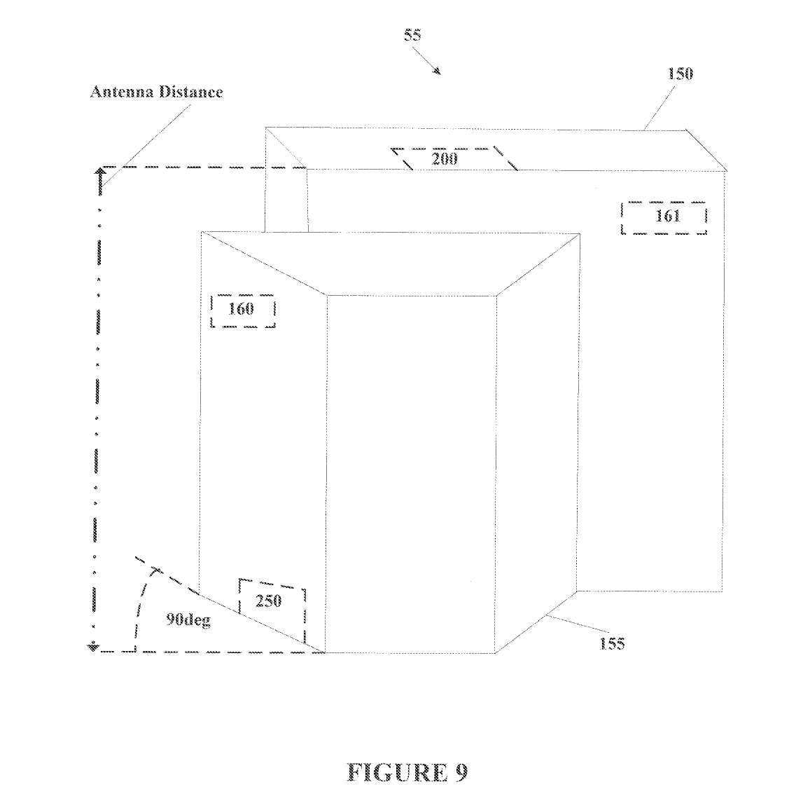

FIGS. 7-9 illustrate a sensor 55 with a first antenna 200 and a second antenna 250. The sensor 55 preferably has a housing 140 with a first section 150 and a second section 155 which is preferably perpendicular to the first section 150. The first section 150 preferably has a pair of plugs 170a-b extending outward to connect with a wall outlet. The first section 150 preferably has a first processor 161 and the second section 155 preferably has a second processor 160. The distance between antennas, as shown in FIG. 9, preferably ranges from 1.5 inches to 3.0 inches.

The two antennas 200 and 250 are preferably mounted a predetermined vertical distance apart and angled at ninety degrees relative to each other. The sensor 55 is preferably wall mounted. Therefore, the first antenna's Z-axis is along the direction of the wall upon which the sensor 55 is mounted, and the second antenna's Z-axis is 90 degree relative to the first antenna 200. In an indoor environment, the Z direction of the second antenna 250 is typically along the direction of an adjacent wall that is perpendicular to the wall the sensor 55 is mounted upon.

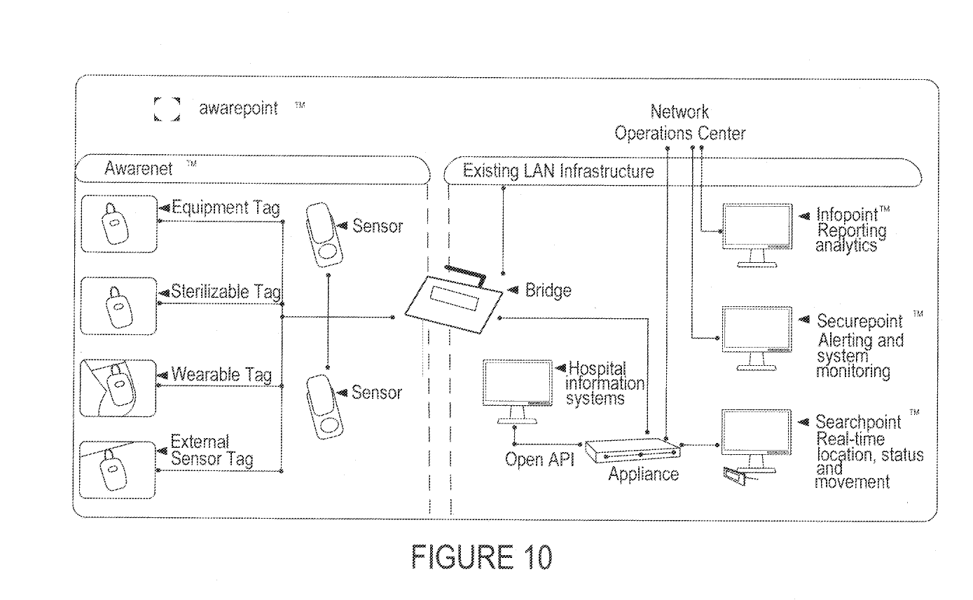

FIG. 10 is a block diagram of a system for determining a real-time location of an object. Sensors receive the messages from the broadcasting tags through attached different antennas, calculate the signal strength, and decide which signal strength to use. The signal strength information is routed to the server for location processing. Bridge/appliance/server devices received signal strength information from the high definitions sensors and make location decisions. The tag sends broadcast messages preferably using ZIGBEE based wireless transmissions. The sensors receive the ZIGBEE based wireless transmissions preferably through two spatially and angularly diverse antennas. Software on each sensor preferably identifies and matches the sending tag and received signal strength readings. Software on each sensor preferably makes local decisions on the final signal strength value for the transponder. Each sensor preferably sends the signal strength information to the appliance through a wireless ZIGBEE based wireless transmission network. The tags and sensors communicate to the bridges preferably through a ZIGBEE based wireless transmission network. The location of the tags is preferably calculated by using the paired signal strength between tags and the sensors that hear the tag. Time slicing is also utilized in determining a real-time location of the object within an indoor facility by making time slots available each antenna.

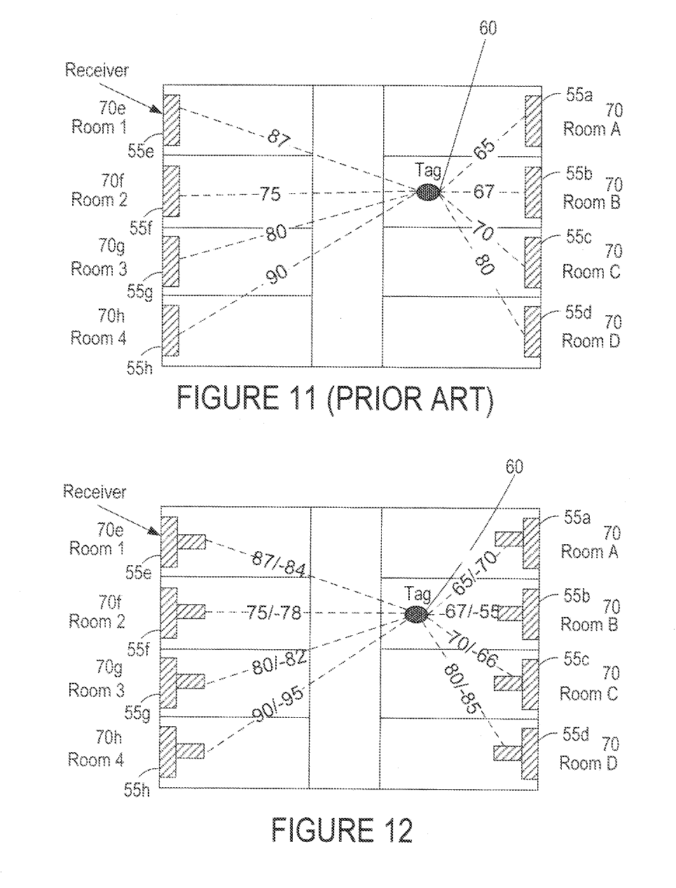

FIG. 11 is an illustration of the prior art of a received signal strength without antenna diversity. The system of FIG. 11 includes a tag 60 attached to an asset or patient, a wireless sensor network composed of sensors 55′a-55′h within rooms 70a-70h, and an appliance, not shown. The sensors 55′a-55′h receive the RF messages broadcasted from the tag 60 and route the signal strength information to the appliance. The asset location is then calculated based on the received signal strengths from surrounding sensors 55′a-55′h. The accuracy of this method however, is subject to small-scale fading due to signal reflections, refraction and scattering. As shown, the sensors 55′ that are further away from the asset typically receive messages broadcasted from the tag 60 with low received signal strength (low received signal strength values). However, because of tags and antenna orientation on the sensor, and multipath, the sensor 55′a in room 70a receives a received signal strength (−65 dbM) which is stronger than room 70b (−67 dbM), which indicates that the tag 60 is closer to the sensor 55′a in room 70a as opposed to the sensor 55′b in room 70b. Therefore, a misclassification of the tag 60 location could occur.

FIG. 12 is an illustration of received signal strength readings from different antennas based on the system of antenna diversities of the present invention. Using a high-definition sensor with antenna diversity implementation, each sensor 55a-55h receives two received signal strength readings from the same message broadcasted from the tag 60, each from a different antenna. Because the two antennas are spatially and angularly diversified, the accurate location is achieved by using the combination of the two antenna readings. For example, the lowest reading of −55 dbM in room 70b over −65 dbM in room 70a indicates the correct tag 60 location. Therefore, the in-room location accuracy is improved using the system of antenna diversity of the present invention.

Further techniques for improving the accuracy include reducing the received signal strength variation between the signal received at the first antenna and the signal received at the second antenna by inputting a transmitter antenna radiation pattern from a transmitter of unknown or arbitrary orientation into the method for determining a real-time location of the object.

Further techniques for improving the accuracy include reducing the received signal strength variation between the signal received at the first antenna and the signal received at the second antenna by positioning the second antenna at a set angle and distance from the first antenna.

Further techniques for improving the accuracy include reducing the received signal strength variation between the signal received at the first antenna and the signal received at the second antenna by inputting a receiver antenna radiation pattern from a receiver of unknown or arbitrary orientation into the method for determining a real-time location of the object.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

We claim as our invention the following:

1. A method for determining a real-time location of an object, the method comprising:
measuring a signal strength of a signal from a tag attached to an object at a first antenna on a sensor;
measuring the signal strength of the signal from the tag at a second antenna on the sensor;
determining if the signal strength measured at least one of the first antenna and the second antenna exceeds a signal strength threshold; and
determining a real-time location of the object based on the signal strength measured at least one of the first antenna and the second antenna.

2. The method according to claim 1 wherein the second antenna is spaced apart from the first antenna a non-integer multiple of a wavelength of the signal from the tag.

3. The method according to claim 1 wherein the real-time location of the object is within a predetermined radius of the sensor.

4. The method according to claim 1 wherein the second antenna is oriented perpendicularly to the first antenna.

5. A method for determining a real-time location of an object, the method comprising:
measuring a signal strength of a signal from a tag attached to an object at a first antenna on a sensor;
measuring the signal strength of the signal from the tag at a second antenna on the sensor;
transmitting signal strength data from the sensor to a location estimation server; and
determining a real-time location of the object at the location estimation server based on the signal strength data from the sensor.

6. The method according to claim 5 wherein the received signal strength variation between the signal received at the first antenna and the signal received at the second antenna is reduced by positioning the second antenna at a set angle and distance from the first antenna.

7. The method according to claim 5 wherein the received signal strength variation between the signal received at the first antenna and the signal received at the second antenna is further reduced by inputting a transmitter antenna radiation pattern from a transmitter of unknown or arbitrary orientation.

8. The method according to claim 5 wherein the received signal strength variation between the signal received at the first antenna and the signal received at the second antenna is further reduced by inputting a receiver antenna radiation pattern from a receiver of unknown or arbitrary orientation.

9. A method for determining a real-time location of an object, the method comprising:
measuring a signal strength of a signal from a tag attached to an object at a first antenna on a first sensor;
measuring the signal strength of the signal from the tag at a second antenna on a second sensor, wherein the first sensor and the second sensor are electromagnetically decoupled;
transmitting signal strength data from the sensor to a location estimation server; and
determining a real-time location of the object at the location estimation server based on the signal strength data from the sensor.

10. The method according to claim 9 wherein electromagnetically decoupled is not reporting the same signal strength from signals that arrive at different angles.

11. A method for determining a real-time location of an object within an indoor facility, the method comprising:
transmitting a wireless signal from a tag associated with an object;
receiving the wireless signal from the tag at a first antenna of at least one sensor of a plurality of sensors positioned within an indoor facility;
receiving the wireless signal at a second antenna of the at least one sensor of the plurality of sensors, the second antenna oriented perpendicularly to the first antenna;
processing the wireless signal received at the first antenna and the wireless signal received at the second antenna to determine a correct signal strength value for the wireless signal from the tag; and
determining a real-time location of the object using the correct signal strength value for the wireless signal from the tag.

12. The method according to claim 11 wherein the second antenna is between 1.5 inches and 3.0 inches from the first antenna.

13. The method according to claim 11 further comprising transmitting the correct signal strength to a positioning engine wherein the positioning engine determines the real-time location of the object.

14. The method according to claim 11 wherein the at least one sensor determines the real-time location of the object, and further comprising transmitting the real-time location of the object to a positioning engine.

15. The method according to claim 11 further comprising measuring at least one of time, angle and received signal strength intensity of the wireless signal from the tag at least one of the first antenna and the second antenna.

16. The method according to claim 11 further comprising performing time slicing for the first antenna and the second antenna using a processor.

17. The method according to claim 11 further comprising performing time slicing for the first antenna using a first processor and for a second antenna using a second processor.

18. The method according to claim 11 further comprising transmitting to a positioning engine from the at least one sensor at least one of a raw signal strength reading of the wireless signal from the tag, an average signal strength reading of the wireless signal from the tag and both signal strength readings of the wireless signal from the tag.

19. The method according to claim 11 wherein the second antenna is spaced apart from the first antenna a non-integer multiple of a wavelength of the wireless signal from the tag.

20. A system for determining a real-time location of an object within an indoor facility, the system comprising:
a plurality of objects, each of the plurality of objects comprising a tag which transmits a wireless signal;
a plurality of sensors positioned within the facility, each of the plurality of sensors comprising a first antenna and a second antenna, the second antenna oriented perpendicularly to the first antenna;
a server in communication with each of the plurality of sensors, the server receiving real-time location data of the object from at least one of a plurality of sensors.

21. The system according to claim 20 wherein the tag transmits a wireless signal at approximately 2.4 GigaHertz using a 802.15.4 communication protocol.

22. A plug-in wireless sensor device for transmitting and receiving tracking information for an object in a facility utilizing an indoor wireless network established within the facility, the plug-in wireless sensor device comprising:
a housing having a first section and a second section oriented perpendicularly to the first section;
a first antenna positioned within the first section of the housing;
a second antenna positioned within the second section of the housing;
at least one processor positioned within the housing for processing a plurality of wireless signals from at least one tag associated with an object, the plurality of wireless signals received at each of the first antenna and the second antenna; and
a plug to physically and electrically connect the plug-in wireless sensor device with a wall outlet of the facility, the plug extending outward from the first section of the housing.
